(19) United States
(12) Patent Application Publication
(10) Pub. No.: US 2024/0401699 A1
(43) Pub. Date: Dec. 5, 2024

(54) SEAL PART FORMING METHOD AND DEVICE ASSEMBLING METHOD

(71) Applicant: Hitachi Astemo, Ltd., Hitachinaka-shi, lbaraki (JP)

(72) Inventors: Yuuichirou YOSHITAKE, Hitachinaka-shi, Ibaraki (JP); Masao FUJIMOTO, Hitachinaka-shi, Ibaraki (JP)

(73) Assignee: Hitachi Astemo, Ltd., Hitachinaka-shi, lbaraki (JP)

(21) Appl. No.: 18/262,723

(22) PCT Filed: Nov. 25, 2021
(86) PCT No.: PCT/JP2021/043106

§ 371 Date: Jul. 24, 2023

(30) Foreign Application Priority Data
Jan. 29, 2021 (JP) 2021-012671

(51) Int. Cl. F16J 15/14

(52) U.S. Cl. CPC F16J 15/14

(57) ABSTRACT

The periphery of a coil terminal portion (9) which penetrates a bottom wall portion (7a) serves as a first seal part forming location (A), and is sealed by an FIPG. The FIPG is used for sealing the spaces between a housing (7) and a motor cover (5) and between a connector member (4) and the motor cover (5) serving as second seal part forming locations (B). A FIPG made of a two-pack room-temperature curing silicone adhesive is used instead of a one-pack thermosetting FIPG, two liquid agents are heated to 60° C. and then are mixed in a static mixer, and the mixture is applied to the seal part forming locations (A, B). The curing time is shortened by preheating, thereby achieving sufficient curing in approximately two hours.

### TECHNICAL FIELD

The present invention relates to a method for forming a seal part of an electronic apparatus mounted on a vehicle, and to a method for assembling a device having the seal part.

### BACKGROUND TECHNOLOGY

For example, in an electronic apparatus such as a control device mounted on a vehicle, a seal part for sealing a casing is required. A patent document 1 discloses a configuration for sealing between a cover and a main body part of a casing of a control device by using a so-called FIPG (Formed in Place Gasket) instead of a conventional molded gasket.

A FIPG is a kind of a liquid adhesive, and in general, a one-pack thermosetting FIPG is used. This thermosetting FIPG is cured in a few hours by being heated at approximately 120-130° C. in a furnace after being applied, for example, to the inside of a sealing groove.

However, in a method using such a thermosetting FIPG, since a temperature for curing of the thermosetting FIPG is relatively high, the curing time including the preheating time for a member to be applied before application and the heat removing time for lowering the temperature after the application is long, and consequently, it becomes a serious obstacle to shorten lead time. In particular, in case where the forming of a seal part inside the casing and the sealing of the casing are required, the forming step of the FIPG for each of them is sequentially carried out, and working time becomes very long.

### PRIOR ART REFERENCE

### Patent Document

Patent Document 1: Japanese Patent Application Publication No. 2020-061437

### SUMMARY OF THE INVENTION

In the present invention, in one aspect thereof, a seal part forming method for forming a seal part between members by using an adhesive capable of being cured at room temperature by mixing a plurality of liquid agents with each other includes: a heating step for heating the plurality of the liquid agents to a temperature higher than at least room temperature, before or after the mixture; and an application step for applying the adhesive formed by the mixture to a seal part forming location, in the heated state.

In another aspect, a seal part forming method for forming a seal part between members by using an adhesive capable of being cured at room temperature by mixing a plurality of liquid agents with each other includes: an application step for applying the adhesive formed by the mixture to a seal part forming location; and a heating step for heating a whole of a member to which the adhesive has been applied or part of a member including at least a part at which the adhesive has been applied to a temperature higher than at least room temperature.

According to the present invention, an adhesive, such as a two-pack room-temperature curing FIPG, which can be cured at room temperature by mixing a plurality of liquid agents is used, and by heating it further, the curing time becomes shorter than that of a common one-pack thermosetting FIPG. In addition, although a common one-pack thermosetting FIPG is cured at a high temperature equal to or higher than 100° C., a relatively low temperature is sufficient for acceleration of curing of the adhesive which is cured at room temperature by the mixture of a plurality of liquid agents, and thereby work becomes easier.

### BRIEF DESCRIPTION OF THE DRAWINGS

FIG. 1 is a perspective exploded view of an electric actuator device for a power steering apparatus to which a method of the present invention is applied.

FIG. 2 is an illustrative view showing the outline of the power steering apparatus.

FIG. 3 is an illustrative view of a second seal part forming location B between a housing and a motor cover.

FIG. 4 is an illustrative view showing an application step of a FIPG material to a seal groove.

### MODE FOR IMPLEMENTING THE INVENTION

In the following, an embodiment of the present invention will be explained in detail based on the drawings.

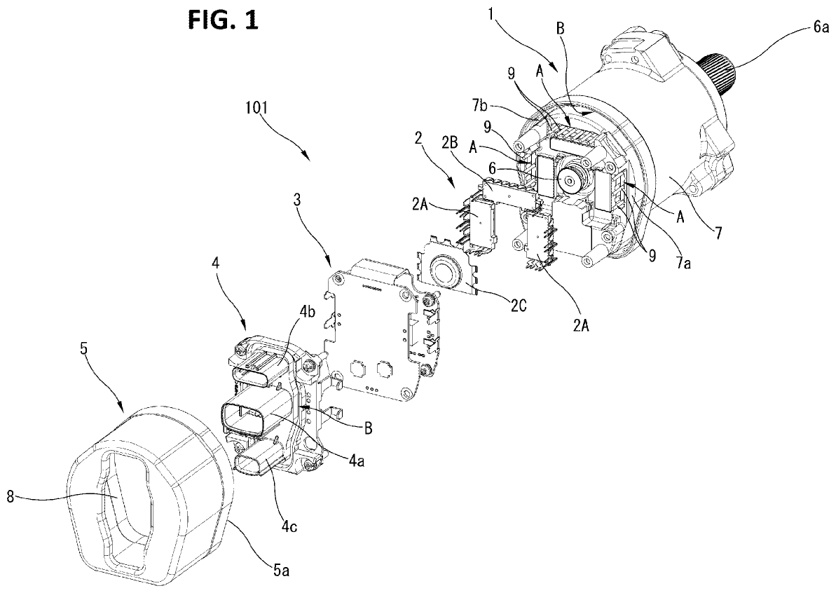

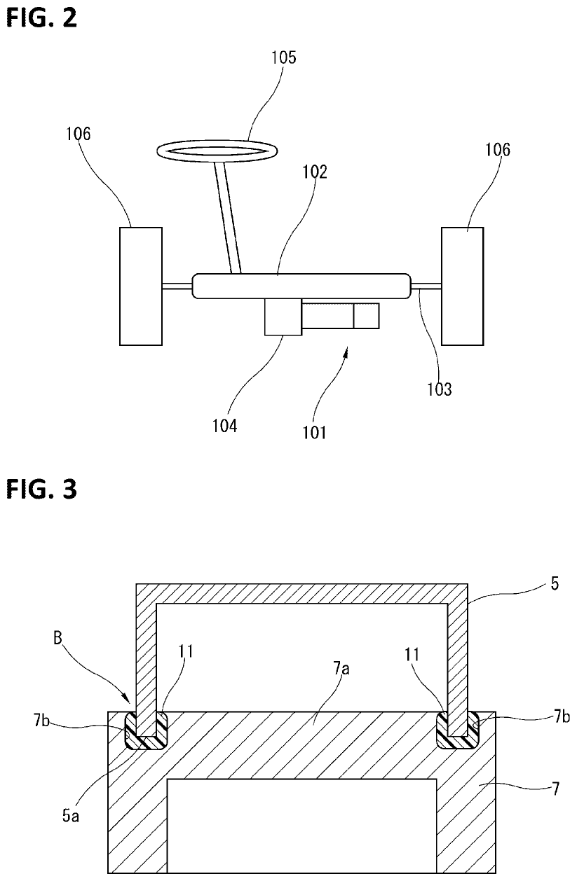

First, one example of an object to which a seal part forming method of the present invention is applied will be explained simply. In an embodiment, the present invention is applied to an electric actuator device 101 of an electric power steering apparatus for an automobile which is shown in FIGS. 1 and 2. In addition, since a basic configuration of the electric actuator device 101 is disclosed, for example, in Japanese Patent Application Publication No. 2020-148639, only a minimum explanation will be described below. FIG. 1 is a perspective exploded view of the electric actuator device 101 for applying steering auxiliary force to a steering mechanism, which is not shown in the drawings, in the electric power steering apparatus, and FIG. 2 is a schematic diagram of the electric power steering apparatus. The electric actuator device 101 is provided with a cylindrical motor part 1, an inverter power module 2, a circuit board 3 formed from a multilayer circuit board which is bent in a substantially U shape, a connector member 4 in which a plurality of connectors are integrally collected, and a motor cover 5 attached to one end portion of the motor part 1 so as to cover the inverter power module 2, the circuit board 3 and the connector member 4.

The motor part 1 is one in which a three-phase AC motor is accommodated in a cylindrical housing 7, includes a connection portion 6a, such as a gear or spline, at a distal end of a rotation shaft 6 protruding from a distal end surface of the housing 7, and is connected to the after-mentioned steering mechanism via the connection portion 6a. A motor is a three-phase permanent magnet brushless motor, and a stator is provided with a three-phase coil, and a permanent magnet is disposed on the outer peripheral surface of the rotor. In addition, the motor is provided with two-system coils and corresponding permanent magnets so as to have redundancy.

One end portion of the housing 7 which is located on the opposite side of the connection portion 6a is formed as a bottom wall portion 7a having a horseshoe-shaped outline of which a part of the outer peripheral edge radially extends, and the motor cover 5 having a horseshoe-shaped outline corresponding to the bottom wall portion 7a is attached so as to cover the bottom wall portion 7a. In addition, the inverter power module 2, the circuit board 3 and the connector member 4 are accommodated in the space formed between the bottom wall portion 7a and the motor cover 5 so as to be superimposed on each other in the axial direction of the rotation shaft 6. Here, as coil terminal portions 9, the both end portions of each coil of the motor protrude toward the motor cover 5 side while penetrating through the bottom wall portion 7a, and are connected to corresponding terminals of the inverter power module 2. Since the motor includes two-system coils, a total of twelve coil terminal portions 9 are arranged on the bottom wall portion 7a.

The inverter power module 2 includes two inverter modules 2A for driving the motor, and a relay module 2B which becomes a neutral point relay of the coils, and these three modules 2A and 2B are disposed so as to have a substantially U shape surrounding the rotation shaft 6. Then, these inverter modules 2A and relay module 2B are fixed to an end surface of the motor part 1 via a retaining member 2C. The coil terminal portions 9 of the coils which are mentioned above are jointed to corresponding terminals of the inverter power module 2 by, for example, TIG welding.

The connector member 4 is provided with three connectors directing to the same direction along the axial direction of the rotation shaft 6. Specifically, the connector member 4 is provided with a power source connector 4a positioned in the middle, a sensor input connector 4b to which signals are input from sensors (such as a steering angle sensor and a torque sensor) disposed on the steering mechanism side, and a communication connector 4c for carrying out communication (for example, CAN communication) with another control apparatus inside a vehicle. These connectors 4a, 4b and 4c protrude to the outside through an opening part 8 of the motor cover 5.

In the electric actuator device 101 in the present embodiment, the after-mentioned FIPG is applied to a first seal part forming location A at the peripheries of the twelve coil terminal portions 9, so as to close the gaps between the coil terminal portions 9 and through holes through which the respective coil terminal portions 9 pass, in the bottom wall portions 7a. With this, the housing 7 which accommodates the motor is sealed. Then, at the time when the motor cover 5 is fixed to the housing 7, the FIPG is similarly applied to a second seal part forming location B between an opening edge 5a of the motor cover 5 and the housing 7. As the second seal part forming location B, a seal groove 7b to be filled with the FIPG is formed at the periphery of the bottom wall portion 7a of the housing 7. With this, the gap between the housing 7 and the motor cover 5 becoming a casing is sealed. In addition, as a part of the second seal part forming location B, the FIPG is also applied to the peripheral edge portion of the connector member 4 matching the opening part 8 of the motor cover 5. In addition, in this example, the housing 7 and the motor cover 5 correspond to an exterior member of claims, and the motor, the coil terminal portions 9 and the like correspond to an internal structure of claims.

FIG. 2 schematically shows a configuration of the electric power steering apparatus including the electric actuator device 101, and corresponds to a drawing when a vehicle is viewed from the upper side. In the illustrated electric power steering apparatus, a rack shaft 103 extending in the width direction of the vehicle is accommodated in a rack case 102, and the electric actuator device 101 is attached to the outer side of the rack case 102 via a speed reduction device 104. When a driver performs rotation operation of a steering wheel 105, the electric actuator device 101 is operated based on detection signals of the steering angle sensor and the torque sensor which are not shown in the drawings, and the rack shaft 103 moves in the axial direction via the speed reduction device 104. With this, steered wheels (front wheels) 106 are turned. The electric actuator device 101 is assembled to the electric power steering apparatus in a posture in which the rotation shaft 6 of the motor is arranged parallel to the rack shaft 103. In this way, since the electric actuator device 101 is located at a position receiving rainwater and the like, waterproof sealing is required to the first seal part forming location A and the second seal part forming location B.

Next, a seal part forming method at the seal part forming locations A and B will be explained.

A two-pack room-temperature curing FIPG made of a silicone adhesive which can be cured at room temperature by mixing a first liquid agent and a second liquid agent is used for the seal part formation of those locations, instead of a conventional one-pack thermosetting FIPG material. Then, before or after the application of the FIPG, it is heated to a temperature higher than room temperature, thereby shortening the curing time.

The seal part formation to the first seal part forming location A, namely a first seal part forming step is carried out before the attachment of the inverter power module 2, the circuit board 3 and the like. The seal part formation to the second seal part forming location B, namely a second seal part forming step is carried out at the time when the motor cover 5 is attached, after the attachment of the inverter power module 2, the circuit board 3 and the like.

### First Embodiment

As a first seal part forming step, a first liquid agent and a second liquid agent are individually heated to 60° C., and are mixed by using a line type static mixer. The static mixer is a mixer having a structure in which a plurality of spiral elements each of which is twisted by 180° are continuously disposed inside a long and narrow circular tube having two liquid inlets, such that the two liquid agents are effectively mixed by receiving dividing action, shifting action and reversing action generated by the elements at the time when the liquid agents flow inside the circular tube. The distal end portion of the static mixer serves as a discharge port of the mixed liquid agents.

The FIPG material having a temperature of 60° C. which has been formed by the mixture is applied to the first seal part forming location A, and is left at room temperature. By the preheating, the curing time is shortened, thereby achieving sufficient curing in approximately two hours. After that, the inverter power module 2, the circuit board 3 and the connector member 4 are attached.

Next, as a second seal part forming step, similar to the first seal part forming step, a first liquid agent and a second liquid agent are individually heated to 60° C., and are mixed by using a line type static mixer. The FIPG material having a temperature of 60° C. which has been formed by the mixture is applied to two second seal part forming locations B (namely, the seal groove 7b of the housing 7 and the periphery of the connector member 4), and then the motor cover 5 is immediately attached. Then, a member to which the FIPG material has been applied is left at room temperature. By the preheating, the curing time is shortened, thereby achieving sufficient curing in approximately two hours. After that, a predetermined airtightness inspection is carried out in order to confirm whether or not sealability is sufficient.

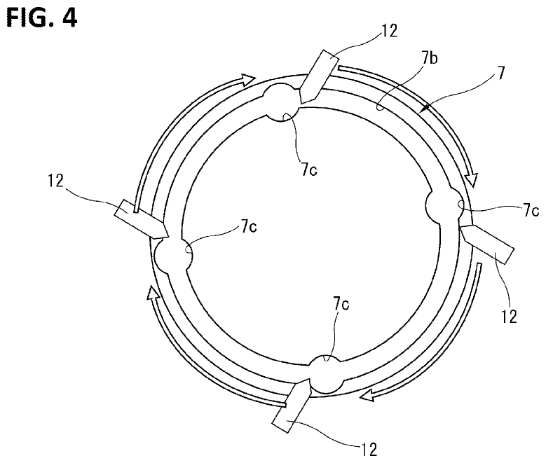

FIG. 3 is an illustrative view, and the seal groove 7b of the housing 7 as a second seal part forming location B and the motor cove 5 are simplified and shown. As illustrated, a FIPG 11 is applied or filled to the seal groove 7b, and the opening edge 5a of the motor cover 5 is fitted thereto.

FIG. 4 is an illustrative view for an application step of the FIPG 11 to the seal groove 7b of the housing 7. As illustrated, by using a plurality of nozzles 12 each discharging the FIPG material before the curing, as shown by arrows, these nozzles 12 are moved along the seal groove 7b and the application is performed. Here, it is preferable to provide a liquid reservoir part 7c, which is formed by partially enlarging the groove width or groove depth, at each position of the seal groove 7b at which the application of each of the nozzles 12 is ended. Due to the preheating, the fluidity of the FIPG material becomes high, and liquid drop from the nozzles 12 easily occurs at the positions of the application end. However, by providing the liquid reservoir part 7c at each of the positions of the application end, the protrusion of an excess material due to the liquid drop is suppressed.

In the above example, in the first seal part forming step and the second seal part forming step, the member applied with the FIPG material is left at room temperature after the application of the FIPG material. However, in one of or the both of the seal part forming steps, as a second heating step, a storage room kept at 40° C. which is a temperature slightly higher than room temperature (for example, 20° C.) is prepared, and the member applied with the FIPG material may be left in this atmosphere of 40° C. In this way, the member applied with the FIPG material is kept at a relatively high temperature after the application, and the curing is further enhanced. In addition, the temperature of the inside of a factory in which various machines and devices are operated could be approximately 30° C. which is a temperature higher than outside air temperature.

In addition, as a heating temperature for the two liquid agents, in the above example, it is set to 60° C. However, since, as a premise, the two-pack room-temperature curing silicone adhesive is cured at room temperature (for example, 20° C.), if the two liquid agents are heated to 30° C. or higher, preferably 50° C. or higher, the curing time can be sufficiently shortened. On the other hand, if the heating temperature is set to an extremely high temperature higher than 100° C., the time until the temperature of the two liquid agents is lowered to a temperature at which the two liquid agents can be handled in the next step becomes longer than the curing time, and it is inefficient. For example, the heating temperature is preferably 70° C. or lower. Therefore, the heating temperature is preferably 30° C. to 70° C. In addition, in order to shorten the time until the temperature of the two liquid agents is lowered to a temperature, at which the two liquid agents can be handled in the next step, so as to be shorter than the curing time in case of being left at room temperature, it is desirable that the heating temperature is preferably higher by 10° C. or more than room temperature.

In addition, in the above example, although the two liquid agents are mixed after being individually heated, the mixed material which has not been heated may be discharged while heating it by a heater provided at the nozzles 12.

### Second Embodiment

As a first seal part forming step, a first liquid agent and a second liquid agent are individually heated to 60° C., and are mixed by using a line type static mixer. The FIPG material having a temperature of 60° C. which has been formed by the mixture is applied to a first seal part forming location A, and then is left at room temperature. By the preheating, the curing time is shortened, thereby achieving sufficient curing in approximately two hours. After that, the inverter power module 2, the circuit board 3 and the connector member 4 are attached.

Next, as a second seal part forming step, a first liquid agent and a second liquid agent are mixed by using a line type mixer without heating them. The FIPG material formed by the mixture is applied to two second seal part forming locations B (that is, the seal groove 7b of the housing 7 and the periphery of the connector member 4), and then the motor cover 5 is attached immediately. Then, local heating is performed to the second seal part forming locations B from the outside by using a heating equipment such as a dryer which discharges hot air. In this way, by performing the heating after the application, the curing time is shortened, thereby achieving sufficient curing in approximately two hours. After that, airtightness inspection is carried out in order to confirm whether or not sealability is sufficient. In addition, it is sufficient that the temperature required for the heating from the outside is approximately 30° C. to 70° C.

In addition, in each of the seal part forming steps, the above-mentioned second heating step may be added.

### Third Embodiment

As a first seal part forming step, a first liquid agent and a second liquid agent are mixed by using a line type static mixer, without heating them. The FIPG maternal formed by the mixture is applied to a first seal part forming location A. Then, before being cured sufficiently, the inverter power module 2, the circuit board 3 and the connector member 4 are attached.

Next, as a second seal part forming step, a first liquid agent and a second liquid agent are mixed by using a line type static mixer, without heating them. The FIPG material formed by the mixture is applied to two second seal part forming locations B (that is, the seal groove 7b of the housing 7 and the periphery of the connector member 4), and then the motor cover 5 is attached immediately. Then, the whole of the assembled electric actuator device 101 is heated to a relatively low temperature (for example, approximately 60° C. to 70° C.) in a heating furnace. In this way, by heating the whole of the electric actuator device 101 inside a heating furnace, the curing time of the FIPG material at the second seal part forming locations B and the first seal part forming location A positioned on the inner side is shortened, thereby achieving sufficient curing in approximately two hours. After that, airtightness inspection is carried out in order to confirm whether or not sealability is sufficient. In addition, the heating temperature of the heating furnace may be lower than a temperature required for curing a common one-pack thermosetting FIPG. Therefore, the configuration of the heating furnace can also be relatively simplified.

The above-mentioned second heating step may be added to the second seal part forming step.

In addition, in the third embodiment in which heating is performed in a furnace, the conventional one-pack thermosetting FIPG material may be used to the second seal part forming locations B.

As the above, although the embodiments of the present invention have been explained, the present invention is not limited to the above embodiments, and various changes can be performed. For example, the first seal part forming step and the second seal part forming step in each of the embodiments can be appropriately combined. In addition, although, as an example, the present invention is applied to the seal part forming of the electric actuator device 101 for the power steering apparatus in each of the embodiments, the present invention can also be applied to sealing of any devices or structures.

As the above, the present invention is a seal part forming method for forming a seal part between members by using an adhesive capable of being cured at room temperature by mixing a plurality of liquid agents with each other, and the method includes: a heating step for heating the plurality of the liquid agents to a temperature higher than at least room temperature, before or after the mixture; and an application step for applying the adhesive formed by the mixture to a seal part forming location, in the heated state.

In another aspect, the present invention is a seal part forming method for forming a seal part between members by using an adhesive capable of being cured at room temperature by mixing a plurality of liquid agents with each other, and the method includes: an application step for applying the adhesive formed by the mixture to a seal part forming location; and a heating step for heating a whole of a member to which the adhesive has been applied or part of a member including at least a part at which the adhesive has been applied to a temperature higher than at least room temperature.

In one preferable aspect, the heating temperature in the heating step is 30° C. to 70° C.

Preferably, the heating temperature in the heating step is in a range from a temperature higher by 10° C. or more than room temperature to a temperature lower than 70° C.

In addition, in another preferable aspect, after each of the steps, a second heating step in which the member is left at an atmospheric temperature heated to a temperature lower than the heating temperature in the heating step is further included.

Furthermore, the present invention is a method for assembling a device in which an internal structure is accommodated in an exterior member, and which is provided with, as seal part forming locations using an adhesive, a first seal part forming location in the internal structure and a second seal part forming location for sealing the exterior member, and the method includes: a first seal part forming step for forming a seal part to the first seal part forming location; and a second seal part forming step for forming a seal part to the second seal part forming location, after the first seal part forming step, wherein the seal part forming method according to any of claims 1 to 5 is applied to at least the first seal part forming step.

Preferably, the seal part forming method according to claim 1 is applied to the first seal part forming step, and the seal part forming method according to claim 2 is applied to the second seal part forming step.

1.-7. (canceled)

8. A seal part forming method for forming a seal part between members by using an adhesive capable of being cured at room temperature by mixing a plurality of liquid agents with each other, the method comprising:
a heating step for heating the plurality of the liquid agents to a temperature higher than at least room temperature, before or after the mixture; and
an application step for applying the adhesive formed by the mixture to a seal part forming location, in the heated state.

9. A seal part forming method for forming a seal part between members by using an adhesive capable of being cured at room temperature by mixing a plurality of liquid agents with each other, the method comprising:
an application step for applying the adhesive formed by the mixture to a seal part forming location; and
a heating step for heating a whole of a member to which the adhesive has been applied or part of a member including at least a part at which the adhesive has been applied to a temperature higher than at least room temperature.

10. The seal part forming method according to claim 8, wherein the heating temperature in the heating step is 30° C. to 70° C.

11. The seal part forming method according to claim 8, wherein the heating temperature in the heating step is in a range from a temperature higher by 10° C. or more than room temperature to a temperature lower than 70° C.

12. The seal part forming method according to claim 8, wherein the heating step is a first heating step, and further comprising after each of the first heating step and the application step, a second heating step in which the member is left at an atmospheric temperature heated to a temperature lower than the heating temperature in the first heating step.

13. A method for assembling a device in which an internal structure is accommodated in an exterior member, and which is provided with, as seal part forming locations using an adhesive, a first seal part forming location in the internal structure and a second seal part forming location for sealing the exterior member, the method comprising:
a first seal part forming step for forming a seal part to the first seal part forming location; and
a second seal part forming step for forming a seal part to the second seal part forming location, after the first seal part forming step,
wherein the seal part forming method according to claim 8 is applied to at least the first seal part forming step.

14. The method for assembling the device according to claim 13, wherein the seal part forming method for forming the seal part between members by using the adhesive capable of being cured at room temperature by mixing the plurality of the liquid agents with each other is applied to the first seal part forming step, the seal part forming method comprising: the heating step for heating the plurality of the liquid agents to the temperature higher than at least room temperature, before or after the mixture; and the application step for applying the adhesive formed by the mixture to the seal part forming location, in the heated state, and
wherein the seal part forming method for forming the seal part between members by using the adhesive capable of being cured at room temperature by mixing the plurality of the liquid agents with each other is applied to the second seal part forming step, the seal part forming method comprising: the application step for applying the adhesive formed by the mixture to the seal part forming location; and the heating step for heating the whole of the member to which the adhesive has been applied or part of the member including at least the part at which the adhesive has been applied to the temperature higher than at least room temperature.

15. The seal part forming method according to claim 9, wherein the heating temperature in the heating step is 30° C. to 70° C.

16. The seal part forming method according to claim 9, wherein the heating temperature in the heating step is in a range from a temperature higher by 10° C. or more than room temperature to a temperature lower than 70° C.

17. The seal part forming method according to claim 9, wherein the heating step is a first heating step, and further comprising after each of the first heating step and the application step, a second heating step in which the member is left at an atmospheric temperature heated to a temperature lower than the heating temperature in the first heating step.

18. A method for assembling a device in which an internal structure is accommodated in an exterior member, and which is provided with, as seal part forming locations using an adhesive, a first seal part forming location in the internal structure and a second seal part forming location for sealing the exterior member, the method comprising:
a first seal part forming step for forming a seal part to the first seal part forming location; and
a second seal part forming step for forming a seal part to the second seal part forming location, after the first seal part forming step,
wherein the seal part forming method according to claim 9 is applied to at least the first seal part forming step.

19. The method for assembling the device according to claim 18, the seal part forming method for forming the seal part between members by using the adhesive capable of being cured at room temperature by mixing the plurality of the liquid agents with each other is applied to the first seal part forming step, the seal part forming method comprising: the heating step for heating the plurality of the liquid agents to the temperature higher than at least room temperature, before or after the mixture; and the application step for applying the adhesive formed by the mixture to the seal part forming location, in the heated state, and
wherein the seal part forming method for forming the seal part between members by using the adhesive capable of being cured at room temperature by mixing the plurality of the liquid agents with each other is applied to the second seal part forming step, the seal part forming method comprising: the application step for applying the adhesive formed by the mixture to the seal part forming location; and the heating step for heating the whole of the member to which the adhesive has been applied or part of the member including at least the part at which the adhesive has been applied to the temperature higher than at least room temperature.
